(19) United States
(12) Patent Application Publication
(10) Pub. No.: US 2005/0071759 A1
(43) Pub. Date: Mar. 31, 2005

(54) Method for an imaging system to form a user interface for a user to accept or request modification to a displayed document, a method for an imaging system to form a user interface for a user to communicate to the imaging system a desired modification in a displayed document, and a method of modifying a displayed document in an imaging system

(75) Inventors: Thomas William Connors, Rochester, NY (US); Matthew Dylan Coene, West Henrietta, NY (US); Kevin Michael Branch, Rochester, NY (US); Raju V. Vegiraju, Pittsford, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/674,049

(22) Filed: Sep. 29, 2003

(51) Int. Cl. G06F 15/00

(52) U.S. Cl. 715/517

(57) ABSTRACT

An imaging system comprises a client device with a display unit, a server controller, stored document information, document modification methods, an imaging device, and documents to be imaged. A user of the client device requests a particular stored document to be displayed on the display unit. The server receives the client request and creates a first user interface for the user to view the stored document and to either accept or request modification to the displayed document. If the user requests modification to the displayed document, the server creates a second user interface for the user to communicate to the imaging system a desired modification to be made in the displayed document. The server determines the best means to address the request, modifies the document, and stores the document information for subsequent use.

### FIELD OF THE INVENTION

This application relates to document imaging systems.

### BACKGROUND OF THE INVENTION

Commercially available document imaging services include document conversion, document storage and document access services. For example, a service provider may scan paper documents or process photographic film to create and store digital documents to a digital repository that may be accessed in a secure and controlled manner by customers. Some of the converted documents stored to the digital repository may not be acceptable to the customer. In existing imaging systems that convert large volumes of documents, even low conversion problem rates may result in a significant number of customer critical documents unacceptable to the customer paying for the imaging system service. Moreover, in repositories storing infrequently-accessed documents, problems may not be detected until a great deal of time has elapsed since the conversion service, the customer does not detect the problem until (s)he actually needs the document, at which time a request to modify the document must be communicated efficiently and resolved quickly. In some cases, because the service provider retains the original document or has the resources and expertise to best manage documents, the service provider must perform the document modification. In such a case, many current imaging systems rely on a manual image modification process in which the end user initiates a phone call (or email) to a “help desk” to request resolution of the problem. Information provided by the customer to modify the document may be lost, misrepresented or not communicated clearly. Existing processes rely on manual recording, notification, and workflows to apply document modifications. The overall process takes too long to resolve the request, is generally inefficient, and costly for both the customer and the service provider.

What is needed, therefore, are methods for improving documents processed and stored in imaging systems.

### BRIEF SUMMARY OF THE INVENTION

In a first aspect of the invention, there is described a method for an imaging system to form a user interface for a user to accept or request modification to a displayed document, comprising:
(a) retrieve a user identification based on the user;
(b) retrieve a document identification corresponding to the displayed document;
(c) retrieve a document content corresponding to the displayed document;
(d) retrieve a document metadata corresponding to the displayed document;
(e) retrieve a document request history corresponding to the displayed document;
(f) form and display a document content rendering based on the document content;
(g) form and display a document metadata rendering based on the document metadata;
(h) form and display a document request history rendering based on the document request history;
(i) form and display a user accept means for the user to accept the displayed document;
(j) form and display a user request modification means for the user to request modification of the document; and
   whereby the user will accept the document content rendering and the document metadata rendering by activating the user accept means or else request modification of the document content rendering and the document metadata rendering by activating the user request modification means.

In a second aspect of the invention, there is described a method for an imaging system to form a user interface for a user to communicate to the imaging system a desired modification in a displayed document, comprising:

by the imaging system:
(a) retrieve a document identification for a displayed document;
(b) determine a document type based on the document identification;
(c) determine a set of allowable modification types based on the document type;
(d) form and display a rendering of the allowable modification types, the rendering of the allowable modification types including modification selecting means for the user to select one or more of the allowable modification types;
(e) retrieve a user identification based on the user;
(f) retrieve the request history of all previously submitted modification requests;
(g) form and display a rendering of the request history, the rendering of the request history including information from image modification requests previously submitted and including means for the user to select one of the previously reported image modification requests that describes the modification that the user desires to make to the current displayed document; and
(h) by the user, communicate to the imaging system the desired modification in the current displayed document by the user's selection of the previously reported problem.

In a third aspect of the invention, there is described a method of modifying a displayed document in an imaging system, comprising:
(a) by a user, communicating to the imaging system a modification request that the displayed document needs to be modified, the modification request including a description of the problem in the displayed document; and

by the imaging system:
(b) receiving the modification request;
(c) based on a plurality of predetermined modification methods, determining which modification method best addresses the modification request, and selecting the modification method so determined, thus forming a selected modification method;
(d) applying the selected modification method to the document, thus forming a modified document; and
(e) storing the modified document.

### BRIEF DESCRIPTION OF THE SEVERAL VIEWS OF THE DRAWING

FIG. 1 depicts an imaging system 100 comprises a client device 1, a server 31, a conversion device 90 and documents 95 accessed by a user 2. As shown, the server 31 comprises a server controller 30 and a storage device 50. The storage device 50 includes a document content 55, a document metadata 60, a user profile 65, a group profile 70, a request history 80 and a document modification map 85. The imaging system 100 is arranged to provide various document imaging services in accordance with an improve document method 99. The improve document method 99 comprises a plurality of methods, namely, a method (generally designated by the reference number 210) for the imaging system 100 to form a user interface 400 for a user to accept or reject a displayed document, a method (generally designated by the reference number 225) for the imaging system 100 to form a user interface 800 for a user to communicate to the imaging system 100 a desired modification in a displayed document, a method (generally designated by the reference number 235) of document modification prioritization, and a method (generally designated by the reference number 240) of modifying a displayed document in the imaging system 100.

FIG. 2 is a high-level flow diagram for the improve document method 99.

FIG. 3 is a flow diagram for the method 210 of FIG. 1.

FIG. 4 depicts a view document data user interface 400 that is created by the method 210 of FIG. 1.

FIG. 5 is a flow diagram for the method 225 of FIG. 1.

FIG. 6 depicts further detail of the storage device 50 of FIG. 1, including the document content 55, the document metadata 60, the user profile 65, the group profile 70, and the request history 80.

FIG. 7 depicts the document modification map 85 of the storage device 50.

FIG. 8 depicts a request document modification user interface 800 that is created by the method 225 of FIG. 1.

FIG. 9 depicts the document modification prioritization method 235 of FIG. 1.

FIG. 10 is a flow diagram for the method 240 of FIG. 1.

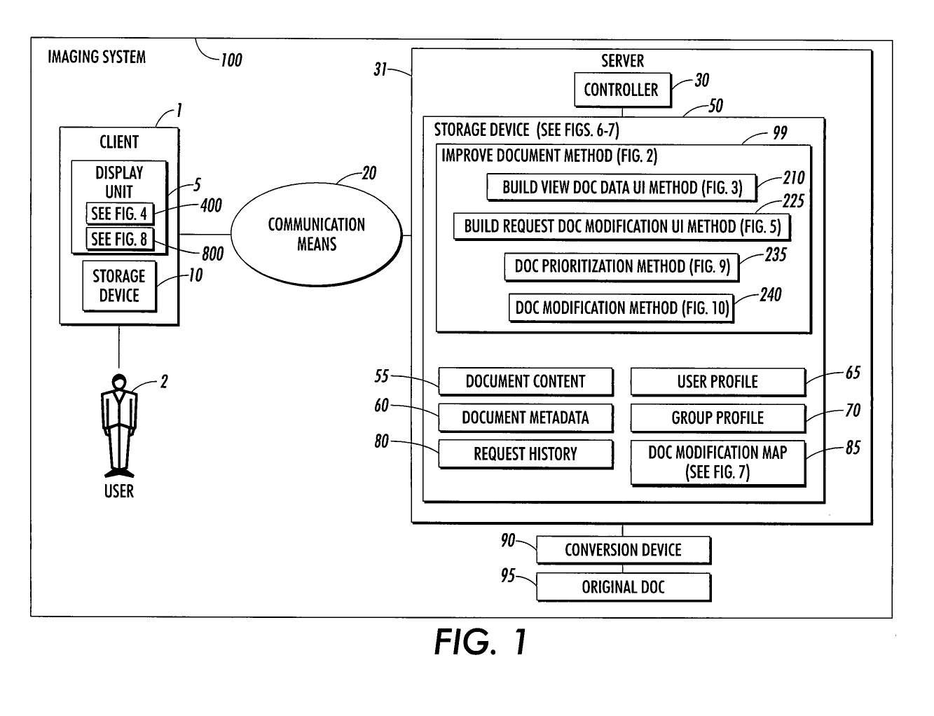

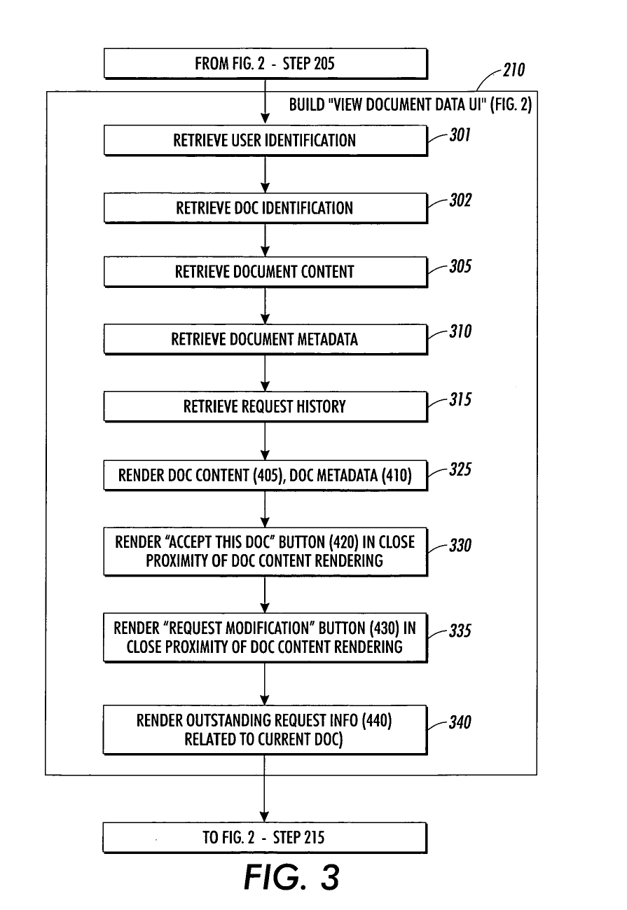

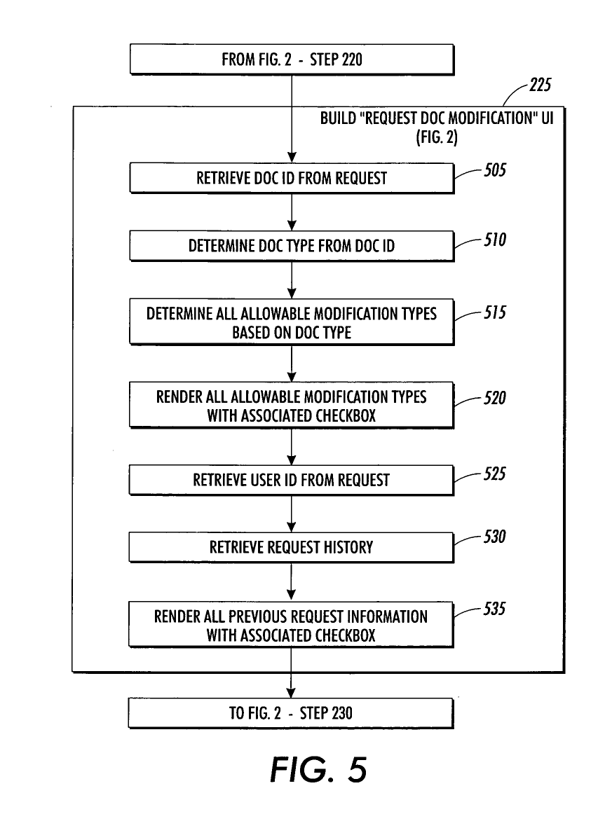

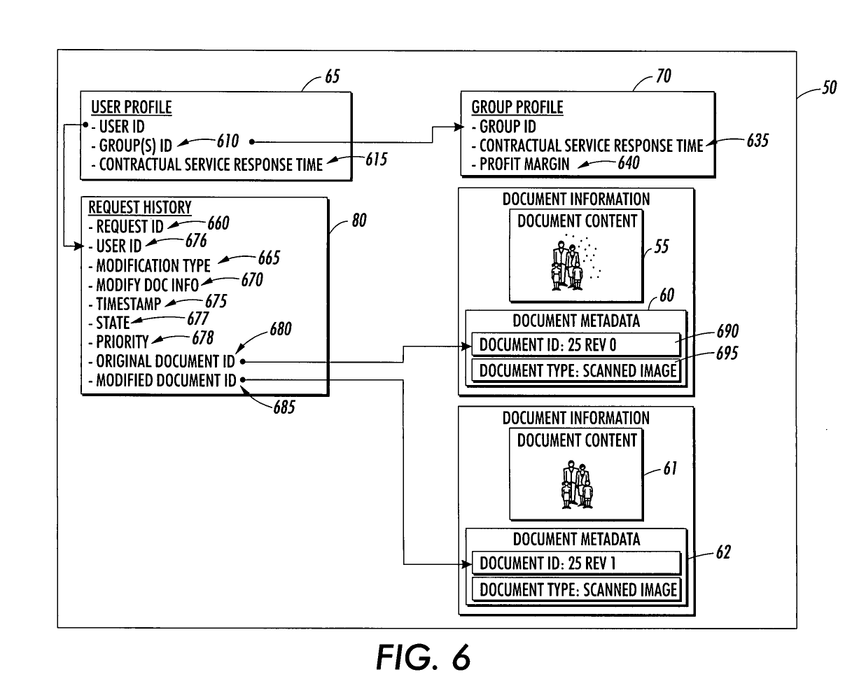

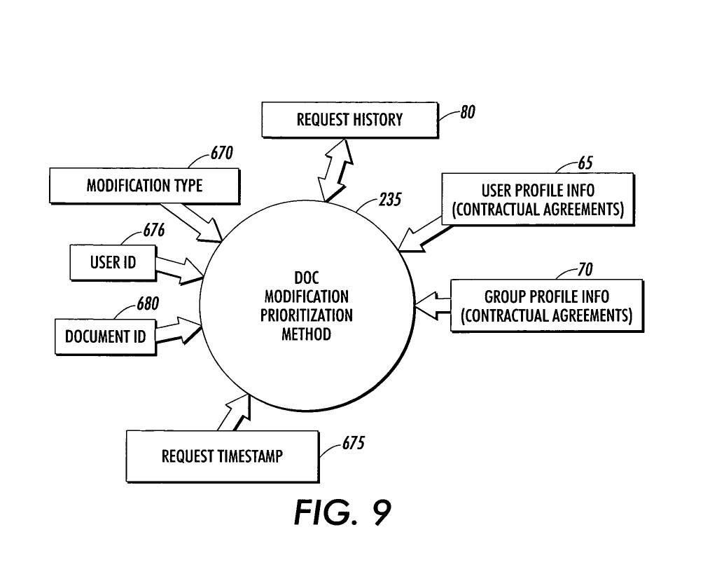

While all FIGS. 1-10 are generally relevant to all aspects of the invention, FIGS. 3-4 and 6 are particularly relevant to the method 210; likewise, FIGS. 5-8 are particularly relevant to the method 225; likewise, FIG. 9 is particularly relevant to the method 235; and likewise, FIGS. 6-7 and 10 are particularly relevant to the method 240.

### DETAILED DESCRIPTION OF THE INVENTION

Briefly, an imaging system 100 comprises a client device 1 with a display unit 5 and a server 31 with stored document image information and stored program instructions. A user 2 of the client device 1 requests an image of a particular stored document to be displayed on the display unit 5. The server 31 receives the client request and creates a first user interface 400 for the user 2 to view the stored document and to either accept or request modification to the displayed document. If the user 2 requests modification to the displayed document, the server creates a second user interface 800 for the user 2 to communicate to the imaging system 100 details of the desired modification to be made in the displayed document. The imaging system 100 then determines the best means of addressing the request, modifies the request, and stores the document for subsequent viewing.

Referring now to FIG. 1 there is shown an imaging system 100 arranged to provide various document imaging services in accordance with the improve document method 99. A client device 1, used by an end user customer or “user” 2, includes a display unit 5 and a storage device 10. The display unit 5 presents the view document data user interface 400 and the request document modification user interface 800. The display unit 5 employs a storage device 10 to facilitate storage of information useful for the client device 1 to render displays and communicate to a server controller 30.

One embodiment of the client device 1 is a personal computer equipped with a monitor. Those skilled in the art will know that in another embodiment, the client device 1 may comprise a handheld digital assistant such as a Palm Handheld. The term “PALM” is a trademark of Palm Inc., Milpitas, Calif.

The client device 1 communicates by means of a communication means 20 to the server. As shown, the server includes a server controller 30. In the preferred embodiment, the communication means 20 comprise hypertext transfer protocol (“http”) over the Internet.

The server 31 includes a controller 30 arranged to access data stored in a storage device 50 that comprises data and stored program instructions. As shown, the stored program instructions include the improve document method 99 which comprises the build “view document data user interface” 400 method 210, the build “request document modification user interface” 800 method 225, the document modification prioritization method 235, and the document modification method 240.

Storage device 50 stores various information pertaining to application of the aforementioned methods including document content 55, document metadata 60 describing the document characteristics of the document content 55, a user profile 65 containing information for each user, a group profile 70 containing information for each group (that consists of users), a request history 80 describing all document modification requests and a document modification map 85.

In one embodiment, the server 31 may be a commonly available computer running an operating system such as a Microsoft Windows Advanced Server 2003. The storage device 50 management may be facilitated by a commercially available content management system such as Documentum eContentServer. The terms “MICROSOFT” and “WINDOWS” are trademarks of the Microsoft Corporation, Redmond, Wash. The terms “DOCUMENTUM” and “ECONTENT SERVER” are trademarks of Documentum, Inc., Pleasanton, Calif.

Imaging system 100 components also include the original hardcopy document 95 to be processed by a conversion device 90.

In one embodiment, the original hardcopy document 95 may be a paper document bearing marks conveying information. The document may be converted to digital data by means of a conversion device 90 such as a document scanner commercially available from many companies including Xerox. The term “Xerox” is a trademark of Xerox Corporation, Stamford, Conn.

In another embodiment, the original hardcopy document 95 may be photographic film containing a photographic image that may be converted to digital format by a film developing and film scanning system, also currently commercially available from such companies as Kodak. The term “Kodak” is a trademark of Kodak Corporation, Rochester, N.Y.

In conversion from an original hardcopy document 95 by means of conversion device 90, the document data gathered and generated is stored as information describing the document content 55 and information describing the document metadata 60.

In one embodiment, the document content 55 is an image of the document rendering, stored in a commonly used, well-defined digital file format. Such formats include tagged image file format (“tiff”) or portable document format (“pdf”).

In one embodiment, the document metadata 60 may be represented as Extensible Markup Language (“XML”).

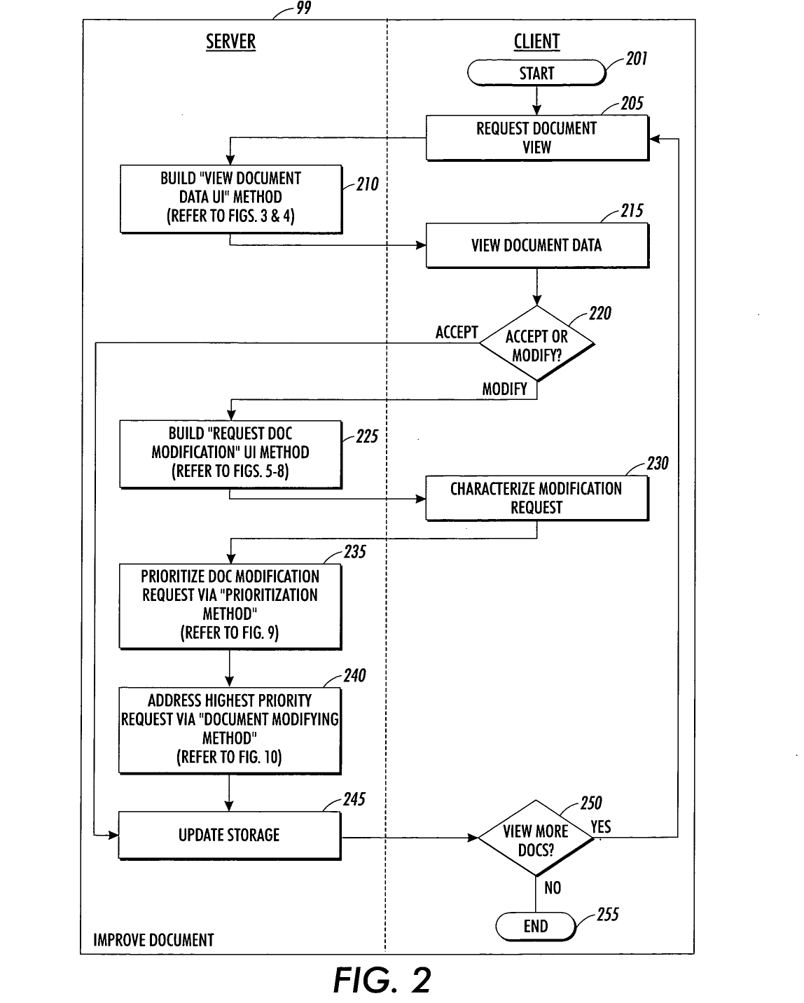

Referring now to FIG. 2 there is shown an embodiment of an improve document method 99 in accordance with the present invention. The process starts at step 201 and proceeds to step 255.

In step 205, the client requests a view of document information stored in the server 31. The request specifies the document identification for the document of interest. The request also specifies a user identification for the current user 2 of the imaging system 100. The request is communicated by means of the client device 1 to the server by means of communication means 20.

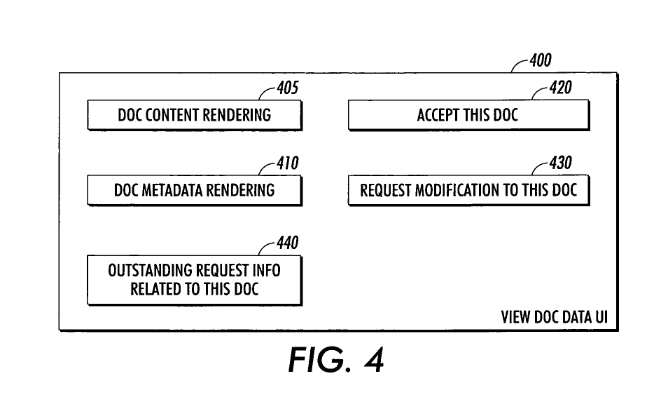

In FIG. 2 step 210, the server controller 30 receives the request and employs the build view document data method 210 to build a user interface 400 for a user to accept or reject a displayed document, one rendering depicted in FIG. 4.

Referring now to FIG. 3 there is shown the details of FIG. 2 step 210 method to build a user interface 400 for a user to accept or request modification to a displayed document.

In FIG. 3 step 301, the server controller 30 retrieves the user identification of the current user 2 of the imaging system 100, as communicated in FIG. 2 step 205.

In FIG. 3 step 302, the server controller 30 retrieves the document identification (“id”) of the current document of interest, as communicated in FIG. 2 step 205.

In FIG. 3 step 305, the server controller 30 retrieves the document content 55 for the specified document from the storage device 50. Referring now to FIG. 6 for details of the data storage 50, the document identification 690 uniquely references the document content 55 and document metadata 60 for each document. Thus, from the document identification 690 retrieved in FIG. 3 step 302, the corresponding document content 55 is retrieved from the storage device 50.

Likewise in FIG. 3, step 310, using the retrieved document identification 690 the server controller 30 retrieves the document metadata 60 for the specified document from the storage device 50.

In step 315, the server controller 30 retrieves the document request history 80 for the specified document from the storage device 50.

Referring now to FIG. 6 for details on FIG. 3 step 315 retrieval of the request history 80. Every modification request is stored in the request history 80. Each modification request contains a document identification 680 uniquely identifying the document for which the request was submitted. With this arrangement of information, given the document identification (as retrieved in FIG. 3 step 302), FIG. 3 process step 315 may retrieve any previously submitted modification requests related to the specified document identification. The FIG. 6 request history 80 information consists of a request identification 660, the user identification 676 corresponding to the user who submitted the request, the modification type 665 characterizing how the document needs to be modified, the modify document information 670 specifying the document modification algorithm to apply, a timestamp 675, a priority 678 denoting the relative importance of addressing the request, a state 677 identifying the request as addressed or not addressed, the original document identification 680 identifying the document for which the modification request was made, and the modified document identification 685 identifying the document created in response to the modification request.

In FIG. 3 steps 325, 330, and 335, the controller renders the aforementioned retrieved information as a user interface 400. One embodiment of the user interface is depicted by FIG. 4 view document data user interface 400.

In FIG. 3 step 325, the controller renders the document content 55, thus forming a document content rendering 405 as depicted in the FIG. 4 document content rendering 405.

Also in FIG. 3 step 325, the controller renders the document metadata 60, thus forming a document metadata rendering 410 as depicted in the FIG. 4 document metadata rendering 410.

In FIG. 3 step 330, the controller builds a user accept means 420 for the user 2 to specify that the current document does not require modification. The means is either enabled or disabled, depending upon the document metadata 60 information retrieved in FIG. 3 step 310. If the document has already been accepted, as indicated by document metadata 60, the user accept means 420 is disabled. Otherwise, if the document has not already been accepted, the user accept means 420 is enabled.

In an example embodiment, the user accept means 420 may be rendered as a World Wide Web user interface click button bearing the label “Accept this doc”, as depicted in FIG. 4.

In FIG. 3 step 335, the controller 30 builds a user request modification means 430 for the user 2 to denote that the current document requires modification. If the document is awaiting modification, as indicated by document metadata 60, the user request modification means 430 is disabled. Otherwise, the user request modification means 430 is enabled.

In an example embodiment, the user request modification means 430 may be rendered as World Wide Web user interface click button bearing the label “Request Modification To This Document”, as depicted in FIG. 4.

In FIG. 3 step 340, the controller 30 uses the previously retrieved request history 80 and document metadata 60 to render outstanding request information 440 related to the current document.

In one embodiment, the outstanding request information 440 may consist of text or icons, or combination of both, conveying the document state as previously “accepted” (by means of FIG. 2 step 220), or conveying the document state as “awaiting modification” as previously indicated by means of FIG. 2 step 220, or as conveying the document state as “waiting for the user 2 to indicate whether or not the document should be modified or accepted”.

Referring now to FIG. 2 step 210, as the last step in the build view document data user interface 400 method 210, the server controller 30 communicates the view document data user interface 400 to the client display unit 5 by means of communication means 20.

The process resumes at FIG. 2 step 215, the client display unit 5 displays the view document data user interface 400.

In FIG. 2 step 220, the user 2 employs the view document data user interface 400 to indicate whether the document “needs modification” or whether the document should be “accepted”. Client 1 communicates the selection to the server controller 30 by means of communication means 20. The communication includes a user identification for the user 2 and a document identification corresponding to the displayed document. If the document “needs modification” (as indicated by means of FIG. 4 element 420) the process proceeds with step 225. If however, the document is “accepted”, (as indicated by means of FIG. 4 element 430) the process proceeds with step 245.

In FIG. 2 step 225, the server employs the build request document modification user interface 800 method depicted in FIG. 5.

Referring now to FIG. 5 there is shown the details of the build request document modification user interface 800 method 225. The process starts with step 505 and proceeds to step 535.

In FIG. 5 step 505, the server controller 30 retrieves the document identification from the user request, which user request is described in connection with FIG. 2 step 205 above.

In FIG. 5 step 510, the process uses the document identification to locate the document metadata 60 stored in storage device 50.

Referring now to FIG. 6 for further details of FIG. 5 step 510, the document metadata 60 includes the document type as well as other document metadata describing the document. By example, a document identification “25 rev 0”, item 690 is of document type “scanned image” item 695. It will be appreciated that, in still further embodiments, alternatives to data structure 60 may be arranged to allow determination of document types based on a document identification. It will be appreciated that FIG. 6 depicts example data and that in practice the document identification 915 and document types are not limited to those depicted.

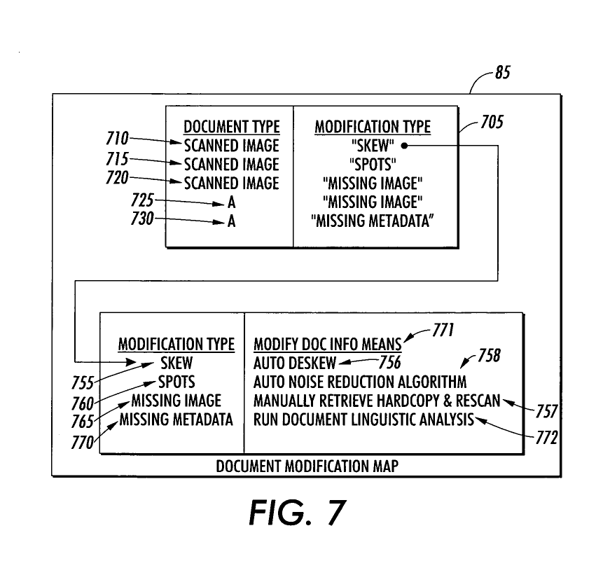

In FIG. 5 step 515, the process determines the allowable modification types for the document based upon the document type. As depicted in FIG. 7, the allowable modification types 705 for all document types are stored in a document modification map 85. In practice, the allowable modification types 705 can be thought of as the types of document problems that could be experienced with a particular document type.

Referring now to FIG. 7 for an example application of FIG. 5 step 515, the allowable modification types 705 data structure specifies by means of items 710, 715, and 720 that document type “scanned image” has 3 allowable modification types, namely, “skew”, “spots” and “missing image”. Likewise, by example, the allowable modification types 705 data structure specifies by means of items 725 and 730 that document type “A” has 2 allowable modification types, namely, “missing image” and “missing metadata”. It will be appreciated that, in still further embodiments, alternatives to data structure 705 may be arranged to allow determination of allowable modification types based on document type. It will be appreciated that FIG. 7 depicts example data and that in practice the document types and modification types are not limited to those depicted.

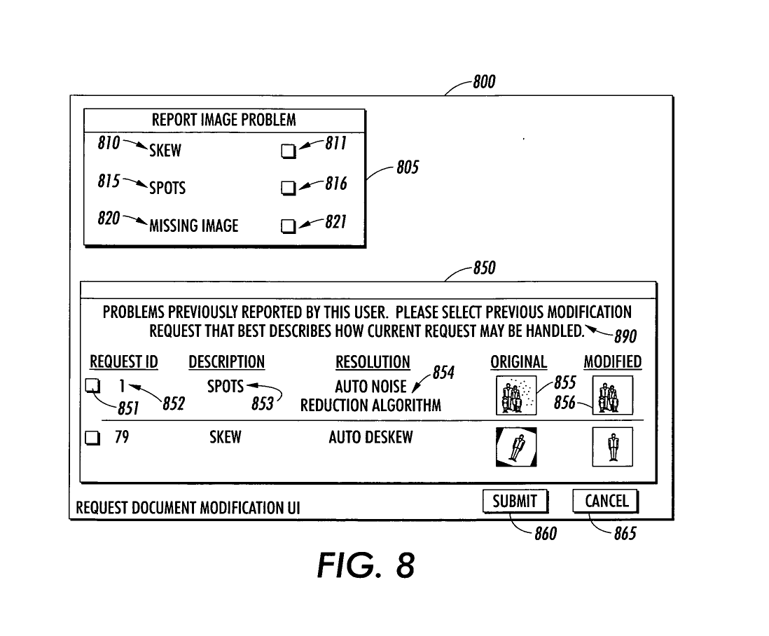

Referring now back to FIG. 5 to resume the process flow for building the request characterization display 805 on request document modification user interface 800, in step 520 the process renders all allowable modification types for the document (as determined in step 515) and provides a means for a user 2 to select one or more of the modification types. FIG. 8 depicts the request document modification user interface 800.

Referring now to FIG. 8 there is shown an example rendering of an allowable modification type “skew” 810 for the document and an example rendering of a means, in the form of checkbox 811, for the user 2 to select modification type “skew” 810 be applied to the document. Likewise, the user interface 800 contains a modification type “spots” 815 that may be selected by means of checkbox 816, a modification type “missing image” 820 that may be selected by means of checkbox 821.

It will be appreciated that, in still further embodiments, there may be alternative arrangements of FIG. 8 request characterization display 805, that convey allowable modification types as well as means to select those allowable modification types.

It will be appreciated that, in still further embodiments, there may be alternative representations of FIG. 8 request characterization display 805, for example, use of icons rather than text to convey the image modification type.

It will also be appreciated that FIG. 8 request characterization display 805 depicts example data and that in practice the allowable modification types are not limited to those depicted.

Referring now back to FIG. 5 to resume the process flow for building a request document modification user interface 800, in step 525, the process retrieves the user identification from the client device 1 request to modify the document.

In FIG. 5 step 530, the process retrieves the request history 80 containing previously reported requests to modify images.

Referring now to FIG. 6 for details on FIG. 5 step 530 retrieval of the request history 80. Each request in the request history 80 contains the user id 676 specifying the user who requested modification. With this arrangement of information, FIG. 5 process step 530 may retrieve all requests previously made by a user 2 requesting modification to the current document.

Again referring to FIG. 6, the request history 80 contains request identification 660 uniquely identifying a document modification request. The request history 80 contains the original document identification 680 pertaining to the document modification request identified in request identification 660. The request history 80 contains modification type(s) 665 associated with the document identified by original document identification 680. With this arrangement of information, FIG. 5 process step 530 may also retrieve all document modification requests previously made for documents having the same modification type as the current document.

Referring now back to FIG. 5 to resume the process flow for building a request document modification user interface 800, step 535 renders previous document modification request information as well as a means to specify that the previous document modification request information characterizes the current document modification request. Step 535 also renders a submit means 860 to communicate the specified user selections and associated information to the server controller 30. Likewise, step 535 renders a cancel means (FIG. 8, reference number 865) to communicate to the server controller 30 that no action is requested pertaining to the request document modification user interface 800.

Referring now to FIG. 8 for a depiction of the request document modification user interface 800 pertaining to FIG. 5 step 535. The request history information display 850 allows a user 2 to select a previously requested modification that best describes the modification request for the current document. The request history information display 850 provides an alternative to request characterization display 805. Whereas request characterization display 805 allows the user 2 to explicitly request a modification type from a display of allowable modification types, the request history information display 850 allows the user to characterize the request by example, using the information from previous requests to effectively characterize the current request. The request history information display 850 contains instructions 890 directing the user 2 on how to use the request history information. The request history information display 850 also contains the request history elements retrieved in preceding step 530. Lastly, the request history information display 850 contains the means 851 to select one or more requests.

In one embodiment of FIG. 8 request history information display 850, the instructional message 890 is “Please select previous modification request that best describes how current requests may be handled”. The displayed request history elements comprise request identification 852 with value “1”, a modification type 853 with value “spots”, modify document information 854 “auto noise reduction algorithm”, a display 855 of the original document content, and a display 856 of the modified document content.

It will be appreciated that, in still further embodiments, there may be alternate arrangements of FIG. 8 request history information display 850 that convey alternative views of the request history including different sort orders, filtering of fields, or different ordering of fields.

It will be appreciated that, in still further embodiments, there may be alternative representations of FIG. 8 request history information display 850, for example, use of icons rather than text to convey the image modification type.

It will also be appreciated that FIG. 8 request history information display 850 depicts example data and that in practice the data values are not limited to that depicted.

Referring now back to FIG. 5, the process flow for building a request document modification user interface 800 ends after completion of step 535.

Referring now to FIG. 2, the method 99 to improve the quality of an image stored in a repository resumes with step 230. In step 230, the process displays the user interface 800 formed by the build request document modification user interface method 225. The user 2 characterizes a document modification request using the user interface 800. The client display unit 5 communicates the document modification request to server controller 30 by means of communication means 20. The document modification request consists of the document identification, user identification, and modification type. Note that the modification type was indicated by the user 2 explicitly by means of FIG. 8 request characterization display 805 or indirectly by means of FIG. 8 request history information display 850. In using FIG. 8 dialog 850 to indicate a request identification previous modification request, the imaging system 100 consults the FIG. 6 request history 80 to obtain the modification type 665 corresponding to the specified request identification 660.

In FIG. 2 step 235, the process prioritizes the document modification request by means of a prioritization method that assigns a priority to document modification requests in the request history 80.

Referring now to FIG. 9 there is shown a data flow diagram of the document modification prioritization method 235. The server controller 30 first stores the modification type 670, user identification 676, and document identification 680 in the request history 80. The server controller then computes a request timestamp 675 for the request and stores the information to the request history 80. Various algorithms may then be applied to determine a priority for the request. Referring to FIG. 6, the process then updates the request history 80 priority element 678 with the calculated priority.

As on prioritization means, the request timestamp 675 may be used to implement a simple as a “first in-first out” approach that assigns priority in descending order of chronological timestamp if request A is received before request B, request A will be assigned a higher priority than request B.

As an alternative prioritization means, referring now to FIG. 6, by using the FIG. 9 user identification 676 to reference the user profile 65 for the user who made the request, the user's contractual service response time 615 may be used to prioritize the request such that requests made by users with a shorter service response time are assigned higher priority than requests made by users with longer service response times.

As an alternative prioritization means, referring still to FIG. 6, by using the FIG. 9 user identification 676 to reference the user profile 65 for the user who made the request, the user's group identification 610 may be used to reference the group profile 70. The group profile 70 contains contractual service response time 635 that may be used to prioritize the request such that requests made by users belonging to a group with a shorter service response time are assigned higher priority than requests made by users belonging to a group having a longer service response time.

As an alternative prioritization means, still referring to FIG. 6, by using the FIG. 9 user identification 676 to reference the user profile 65 for the user who made the request, the user's group identification 610 may be used to reference the group profile 70. The group profile 70 contains profit margin 640 that may be used to prioritize the request such that requests made by users belonging to a group with a higher profit margin are assigned higher priority than requests made by users belonging to a group having a lower profit margin.

As an alternative prioritization means, referring still to FIG. 6, by using the FIG. 9 user identification 676 to reference the request history 80, all requests previously made by a user or by a group may be tallied. The frequency of requests made by a user or a group may be used to assign priority to requests such that requests made by users with a higher frequency of outstanding requests are given higher priority than requests made by users with lower frequency of outstanding requests.

Now referring back to FIG. 2 to resume the improve document method 99 description, after step 235 prioritization, step 240 addresses the highest priority request by applying the method of modifying a displayed document in an imaging system.

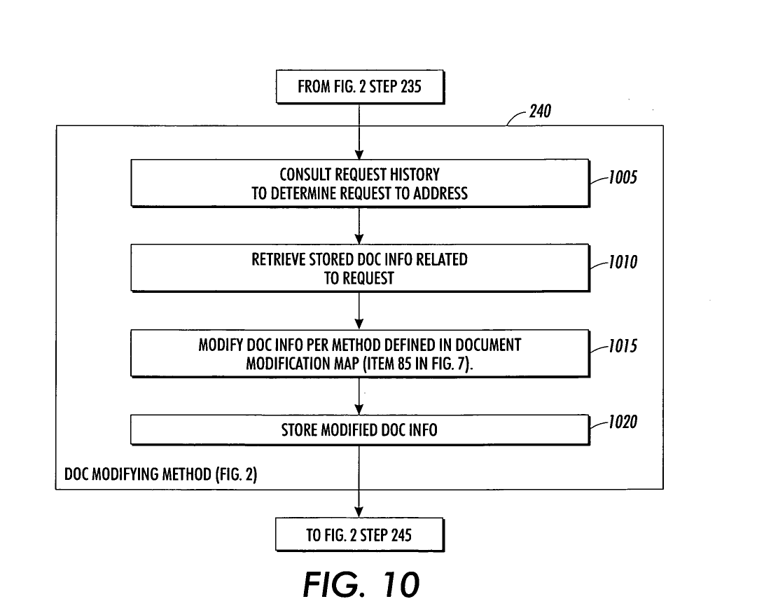

Referring now to FIG. 10 there is shown the details of the method 240 of modifying a displayed document in an imaging system. The process starts with step 1005 and ends with step 1025.

In FIG. 10 step 1005, the process consults the request history 80 to determine which request to address. Referring to FIG. 6 request history 80, the process first determines the request identification 660 for any request having a state 677 indicating that the request has not been addressed. The process then selects from unresolved requests, the request identification 660 corresponding to the request with highest priority 678.

In FIG. 10 step 1010, the process consults the request history 80 to retrieve the information relevant to the request selected in step 1005. Namely, referring to FIG. 6 request history 80, the process first retrieves the original document identification 690 corresponding to the request identification 660. Using the request history 80 original document identification 680 to reference the document identification 690, the process retrieves the document content 55 and the document metadata 60. Next, the process retrieves the request history 80 modification type 665 that was indicated in the modification request submitted by means of the user interface 800. Referring now to FIG. 7, the process consults the document modification map 85, using the modification type 665 to look up the appropriate modify document information means 771. The modify document information means 771 represents the steps to take to address the specified modification type.

By way of example, if the request to be addressed has a modification type value “skew”, 755 the corresponding means to modify the image is to run the “auto de-skew” 756 algorithm. Likewise, for the modification type value “spots” 760, the corresponding means to modify the image is to run the “auto noise reduction algorithm” 758. Likewise, if the modification type value “missing image”, 765 the corresponding means to modify the image is to “manually retrieve hardcopy and rescan” 757 process. Likewise, for the modification type value “missing metadata” 770, the corresponding means to modify the image is to “run document linguistic analysis” 772.

In FIG. 10 step 1015, the process applies the modify document information means 771 determined in step 1010. The modify document information means 771 may refer to a document containing process steps to address the problem. The modify document information means 771 may refer to a computer algorithm that the server controller 30 executes on the document content 55 or the document metadata 60 to address the modification request. In step 1015, the application of the modify document information means 771 results in modified document metadata 60, revised document content 55, or both.

In FIG. 10 step 1020, the process concludes by storing the modified document metadata 60 and revised document content 55 as a new document in storage device 50. By way of example, FIG. 6 depicts a new document content 61 and new document metadata 62 created after application of FIG. 7 “Auto noise reduction algorithm” 758.

Referring now back to FIG. 2, in step 245 the modify document process 99 updates the storage 50. If the process has come from step 240, FIG. 6 request history 80 state 677 is changed to indicate that the request has been addressed.

In FIG. 2 step 250, the process allows the user 2 to process more documents. If the user 2 wants to process additional documents, the process cycles back to step 205. If the user 2 does not want to process additional documents, the process concludes with step 255.

In summary, there has been described the first aspect of the invention, described in claim 1 below, namely, the method 210 for an imaging system 100 to form a user interface 400 for a user 2 to accept or request modification to a displayed document, comprising:
(a) in step 301, retrieve a user identification based on the user;
(b) in step 302, retrieve a document identification corresponding to the displayed document;
(c) in step 305, retrieve a document content 55 corresponding to the displayed document;
(d) in step 310, retrieve a document metadata 60 corresponding to the displayed document;
(e) in step 315, retrieve a document request history 80 corresponding to the displayed document;
(f) in step 325, form and display a document content rendering 405 based on the document content 55;
(g) in step 325, form and display a document metadata rendering 410 based on the document metadata 60;
(h) in step 340, form and display a document request history rendering 440 based on the document request history 80;
(i) in step 330, form and display a user accept means 420 for the user 2 to accept the displayed document; and
(j) in step 335, form and display a user request modification means 430 for the user 2 to request modification of the document;
   whereby the user 2 in step 220 will accept the document content rendering 405 and the document metadata rendering 410 by activating the user accept means 420 or else in step 220 request modification of the document content rendering 405 and the document metadata rendering 410 by activating the user request modification means 430.

In one embodiment, described in claim 2 below, the imaging system 100 comprises a client device 1, the client device 1 comprising a display unit 5.

In one embodiment, described in claim 3 below, the client device 1 comprises any of a handheld digital assistant and a personal computer equipped with a monitor.

In one embodiment, described in claim 4 below, the display unit 5 is arranged to display the document content rendering 405, the document metadata rendering 410, the document request history rendering 440, the user accept means 420 and the user request modification means 430.

In one embodiment, described in claim 5 below, the user accept means 420 comprises a user click button.

In one embodiment, described in claim 6 below, the user request modification means 430 comprises a user click button.

In one embodiment, described in claim 7 below, the imaging system 100 further comprises a server.

In one embodiment, described in claim 8 below, the server and the client device 1 are arranged to communicate by means of a communication means 20.

In one embodiment, described in claim 9 below, the communication means 20 comprises an internet communication system.

In one embodiment, described in claim 10 below, the method 210 includes a step 205, by the client device 1, of communicating to the server by means of the communication means 20 a request for a view of document information stored in the server.

In one embodiment, described in claim 11 below, the request specifies the document identification 915 for the displayed document.

In one embodiment, described in claim 12 below, the method 210 includes a step, by the server, of forming a view document data user interface 400, the view document data user interface 400 comprising the document content rendering 405, the document metadata rendering 410, the document request history rendering 440, the user accept means 420 and the user request modification means 430.

In one embodiment, described in claim 13 below, the method 210 includes a step, by the server, of communicating the view document data user interface 400 to the client device 1 by means of the communication means 20.

In one embodiment, described in claim 14 below, the method 210 includes a step 220, by the user 2, of forming a user selection comprising either accepting the document content rendering 405 and the document metadata rendering 410 by in step 220 activating the user accept means 420 or else requesting modification of the document content rendering 405 and the document metadata rendering 410 by in step 220 activating the user request modification means 430.

In one embodiment, described in claim 15 below, the step 220 includes a step, by the client device 1, of communicating the user selection to the server by means of the communication means 20.

Also, there has been described the second aspect of the invention, described in claim 16 below, namely, the method 225 for an imaging system 100 to form a user interface 800 for a user 2 to communicate to the imaging system 100 a desired modification in a displayed document, comprising:

by the imaging system 100:

(a) in step 505, retrieve a document identification 915 for a displayed document;
(b) in step 510, determine a document type based on the document identification 915;
(c) in step 515, determine a set 705 of allowable modification types based on the document type;
(d) in step 520, form and display a rendering 805 of the allowable modification types 810, 815, 820, the rendering 805 of the allowable modification types including modification selecting means 811, 816, 821 for the user 2 to select one or more of the allowable modification types;
(e) in step 525, retrieve a user identification 676 based on the user 2;
(f) in step 530, retrieve the request history 80 of all previously submitted modification requests;
(g) in step 535, form and display a rendering 850 of the request history, the rendering 805 of the request history including information from image modification requests previously submitted and including means 851, 79 for the user 2 to select one of the previously reported image modification requests that describes the modification that the user 2 desires to make to the current displayed document; and
(h) in step 230, by the user 2, communicate to the imaging system 100 the desired modification in the current displayed document by the user 2's selection of the previously reported problem.

In one embodiment, described in claim 17 below, the imaging system 100 comprises a client device 1, the client device 1 comprising a display unit 5.

In one embodiment, described in claim 18 below, the client device 1 comprises any of a handheld digital assistant and a personal computer equipped with a monitor.

In one embodiment, described in claim 19 below, the allowable modification types comprise any of skew, spots, missing image and missing metadata.

In one embodiment, described in claim 20 below, the display unit 5 arranged to display the rendering 805 of the allowable modification types, the modification selecting means 811, 816, 821 for the user 2 to select one or more of the allowable modification types, the rendering 850 of the request history and the means 851, 79 for the user 2 to select one of the previously reported image modification requests that describes the modification that the user 2 desires to make to the current displayed document.

In one embodiment, described in claim 21 below, the modification selecting means 811, 816, 821 for the user 2 to select one or more of the allowable modification types comprises one or more checkboxes 811, 816, 821 that may be selected by the user 2.

In one embodiment, described in claim 22 below, the means 851, 79 for the user 2 to select one of the previously reported image modification requests that describes the modification that the user 2 desires to make to the current displayed document comprises one or more checkboxes 851, 79 that may be selected by the user 2.

In one embodiment, described in claim 23 below, the imaging system 100 further comprises a server.

In one embodiment, described in claim 24 below, the server and the client device 1 arranged to communicate by means of a communication means 20.

In one embodiment, described in claim 25 below, the communication means 20 comprises an internet communication system.

In one embodiment, described in claim 26 below, the method 225 includes a step 205, by the client device 1, of communicating to the server by means of the communication means 20 a request for a view of document information stored in the server.

In one embodiment, described in claim 27 below, the request specifying the document identification 915 for the displayed document.

In one embodiment, described in claim 28 below, the method 225 includes a step, by the server, of forming a request document modification user interface 800, the request document modification user interface 800 comprising the rendering 805 of the allowable modification types and the rendering 850 of the request history.

In one embodiment, described in claim 29 below, the method 225 includes a step, by the server, of communicating the request document modification user interface 800 to the client device 1 by means of the communication means 20.

In one embodiment, described in claim 30 below, the method 225 includes a step 230, by the user 2, of selecting one of the previously reported image modification requests that describes the modification that the user 2 desires to make to the current displayed document, thus forming a user selection.

In one embodiment, described in claim 31 below, the method 225 includes a step 230, by the client device 1, of communicating the user selection to the server by means of the communication means 20.

Also, there has been described the third aspect of the invention, described in claim 32 below, namely, the method 240 of modifying a displayed document in the imaging system 100, comprising:
(a) by a user 2, in step 220, communicating to the imaging system 100 a modification request that the displayed document needs to be modified, the modification request including a description (formed in step 230) of the problem in the displayed document; and

by the imaging system 100:
(b) receiving the modification request;
(c) based on a plurality of predetermined modification methods, determining which modification method best addresses the modification request, and selecting the modification method so determined, thus forming a selected modification method;
(d) applying the selected modification method to the document, thus forming a modified document; and
(e) storing the modified document.

While various embodiments of a method for an imaging system to form a user interface for a user to accept or request modification to a displayed document, a method for an imaging system to form a user interface for a user to communicate to the imaging system a desired modification in a displayed document, and a method of modifying a displayed document in an imaging system, in accordance with the present invention, have been described hereinabove, the scope of the invention is defined by the following claims.

1. A method for an imaging system to form a user interface for a user to accept or request modification to a displayed document, comprising:
(a) retrieve a user identification based on the user;
(b) retrieve a document identification corresponding to the displayed document;
(c) retrieve a document content corresponding to the displayed document;
(d) retrieve a document metadata corresponding to the displayed document;
(e) retrieve a document request history corresponding to the displayed document;
(f) form and display a document content rendering based on the document content;
(g) form and display a document metadata rendering based on the document metadata;
(h) form and display a document request history rendering based on the document request history;
(i) form and display a user accept means for the user to accept the displayed document;
(j) form and display a user request modification means for the user to request modification of the document; and
whereby the user will accept the document content rendering and the document metadata rendering by activating the user accept means or else request modification of the document content rendering and the document metadata rendering by activating the user request modification means.

2. The method of claim 1, the imaging system comprising a client device, the client device comprising a display unit.

3. The method of claim 2, the client device comprising any of a handheld digital assistant and a personal computer equipped with a monitor.

4. The method of claim 2, the display unit arranged to display the document content rendering, the document metadata rendering, the document request history rendering, the user accept means and the user request modification means.

5. The method of claim 4, the user accept means comprising a user click button.

6. The method of claim 4, the user request modification means comprising a user click button.

7. The method of claim 4, the imaging system further comprising a server.

8. The method of claim 7, the server and the client device arranged to communicate by means of a communication means.

9. The method of claim 8, the communication means comprising an internet communication system.

10. The method of claim 8 including a step, by the client device, of communicating to the server by means of the communication means a request for a view of document information stored in the server.

11. The method of claim 10, the request specifying the document identification for the displayed document.

12. The method of claim 11 including a step, by the server, of forming a view document data user interface, the view document data user interface comprising the document content rendering, the document metadata rendering, the document request history rendering, the user accept means and the user request modification means.

13. The method of claim 12 including a step, by the server, of communicating the view document data user interface to the client device by means of the communication means.

14. The method of claim 13 including a step, by the user, of forming a user selection comprising either accepting the document content rendering and the document metadata rendering by activating the user accept means or else requesting modification of the document content rendering and the document metadata rendering by activating the user request modification means.

15. The method of claim 14 including a step, by the client device, of communicating the user selection to the server by means of the communication means.

16. A method for an imaging system to form a user interface for a user to communicate to the imaging system a desired modification in a displayed document, comprising:
by the imaging system:
(a) retrieve a document identification for a displayed document;
(b) determine a document type based on the document identification;
(c) determine a set of allowable modification types based on the document type;
(d) form and display a rendering of the allowable modification types, the rendering of the allowable modification types including modification-selecting means for the user to select one or more of the allowable modification types;
(e) retrieve a user identification based on the user;
(f) retrieve the request history of all previously submitted modification requests;
(g) form and display a rendering of the request history, the rendering of the request history including information from image modification requests previously submitted and including means for the user to select one of the previously reported image modification requests that describes the modification that the user desires to make to the current displayed document; and
(h) by the user, communicate to the imaging system the desired modification in the current displayed document by the user's selection of the previously requested modification.

17. The method of claim 16, the imaging system comprising a client device, the client device comprising a display unit.

18. The method of claim 17, the client device comprising any of a handheld digital assistant and a personal computer equipped with a monitor.

19. The method of claim 17, the allowable modification types comprising any of skew, spots, missing image and missing metadata.

20. The method of claim 17, the display unit arranged to display the rendering of the allowable modification types, the modification-selecting means for the user to select one or more of the allowable modification types, the rendering of the request history and the means for the user to select one of the previously reported image modification requests that describes the modification that the user desires to make to the current displayed document.

21. The method of claim 20, the modification selecting means for the user to select one or more of the allowable modification types comprising one or more checkboxes that may be selected by the user.

22. The method of claim 20, the means for the user to select one of the previously reported image modification requests that describes the modification that the user desires to make to the current displayed document comprising one or more checkboxes that may be selected by the user.

23. The method of claim 20, the imaging system further comprising a server.

24. The method of claim 23, the server and the client device arranged to communicate by means of a communication means.

25. The method of claim 24, the communication means comprising an internet communication system.

26. The method of claim 24 including a step, by the client device, of communicating to the server by means of the communication means a request for a view of document information stored in the server.

27. The method of claim 26, the request specifying the document identification for the displayed document.

28. The method of claim 27 including a step, by the server, of forming a request document modification user interface, the request document modification user interface comprising the rendering of the allowable modification types and the rendering of the request history.

29. The method of claim 28 including a step, by the server, of communicating the request document modification user interface to the client device by means of the communication means.

30. The method of claim 29 including a step, by the user, of selecting one of the previously reported image modification requests that describes the modification that the user desires to make to the current displayed document, thus forming a user selection.

31. The method of claim 30 including a step, by the client device, of communicating the user selection to the server by means of the communication means.

32. A method of modifying a displayed document in an imaging system, comprising:
(a) by a user, communicating to the imaging system a modification request that the displayed document needs to be modified, the modification request including a description of the problem in the displayed document; and
by the imaging system:
(b) receiving the modification request;
(c) based on a plurality of predetermined modification methods, determining which modification method best addresses the modification request, and selecting the modification method so determined, thus forming a selected modification method;
(d) applying the selected modification method to the document, thus forming a modified document; and
(e) storing the modified document.
